(19) United States
(12) Patent Application Publication
(10) Pub. No.: US 2024/0275600 A1
(43) Pub. Date: Aug. 15, 2024

(54) SECURE ELEMENT, METHOD FOR REGISTERING TOKENS, AND TOKEN REFERENCE REGISTER

(71) Applicant: GIESECKE+DEVRIENT ADVANCE52 GMBH, Munchen (DE)

(72) Inventors: Raoul-Thomas HERBORG, Worthsee (DE); Daniel ALBERT, Munchen (DE)

(21) Appl. No.: 18/681,044

(22) PCT Filed: Jul. 12, 2022
(86) PCT No.: PCT/EP2022/025325

§ 371 Date: Feb. 3, 2024

(30) Foreign Application Priority Data
Aug. 4, 2021 (DE) 10 2021 004 020.1

(51) Int. Cl. H04L 9/32; G06Q 20/38; G06Q 20/40; H04L 9/08

(52) U.S. Cl. CPC H04L 9/3213; G06Q 20/3823; G06Q 20/3829; G06Q 20/401; H04L 9/0825

(57) ABSTRACT

A secure element relates to a token reference register and to a method for registering tokens of an electronic transaction system. Each token of the transaction system comprises at least a token value and a private part of a token-individual key pair as token elements.

### FIELD OF THE DISCLOSURE

The invention relates to a method for registering tokens, in particular a secure element as a transaction unit, to a secure element and to a token reference register in which token references which are uniquely assigned to a token are stored, and to the transaction system overall.

### BACKGROUND

With the aid of secure elements, such as chip cards, SIM modules, etc., as transaction units, it is known that a secure direct transmission between the transaction units can be achieved, wherein deliberate multiple outputs of tokens, also referred to as double-spending, are already ruled out.

For example, DE 10 2009 038 645 A1 and DE 10 2009 034 436 A1 describe systems or portable data carriers as secure elements for transmitting monetary values in the form of electronic data sets in which payment with duplicates of the data set is prevented and a high degree of manipulation security is provided. Complex structures and complex encryption and signing processes for the transactions are required here. These have not been found to be very practicable.

The security of transactions and of the associated transaction data includes protection of the confidentiality of the exchanged data as well as protection of the integrity of the exchanged data and also protection of the availability of the exchanged data.

A distinction is often made between token-based systems and account-based systems as solution approaches for secure transaction systems. In addition to conventional account-based systems, recently newer kinds of account-based systems based on blockchain topologies have been discussed. Although they provide high protection of integrity, they also publish a great deal of information, for example if there are data sets present in a freely readable data structure and change the owner there.

It is likewise already known to expand a token-based transaction system by a token register. The secure clement sends a registration request for its token to the register. The register verifies the registration request and preferably only stores a token reference for the token, that is to say preferably does not know the token itself. The invention uses a method for registering tokens that can be transmitted directly between subscriber units.

WO 2020/212337 A1 describes a transaction system in which even modifications at the token—for example by splitting the token—are possible in a secured fashion off-line, that is to say, directly between the secure elements of the transaction system and without a further control entity. After receipt in a secure element or a subscriber unit, the tokens can be immediately transmitted further without a modification having to be registered in a token register of the transaction system. However, the secure elements are known to be resource-limited, in particular limited with regard to memory space and/or processing speed.

### SUMMARY

The object of the invention is to create a secure element and a method for registering tokens of a transaction system, in which a transmission of tokens is designed to be secure but nevertheless simple enough—especially for secure elements.

In particular, a direct transmission of a token, optionally a modified token, between subscriber units is to be created. This transaction should remain anonymous for third parties. After receipt in a subscriber unit, the token should be immediately able to be used further in order to enable a transaction even without connection to a remote unit, for example to a central register or a decentralized ledger. A received token should on the one hand be secret with respect to subscriber units not involved in the transaction. Each subscriber unit of the transaction system should be able to check a token obtained; in particular multiple output attempts and attempts to transmit unavailable token values can be detected by a subscriber unit or generally in the transaction system.

The object is achieved in particular by a method for registering tokens of an electronic transaction system, wherein each token of the transaction system comprises at least a token value and a private part of a token-individual key pair as token elements.

The method comprises the method steps of: receiving, in a token reference register of the transaction system, a registration request comprising at least one token reference uniquely assigned to a token of the transaction system, wherein the token reference comprises at least the token value of the token and a public part of the token-individual key pair as token reference elements, wherein the public part of the token-individual key pair was obtained by applying a cryptographic one-way function to the private part of the token-individual key pair, verifying, using a verification unit of the token reference register, whether the at least one token reference of the received registration request is stored in the token reference register, and storing the at least one token reference in a memory unit of the token reference register in order to register the token uniquely assigned to this token reference in the transaction system, and storing the at least one token reference in a memory unit of the token reference register in order to register the token uniquely assigned to this token reference in the transaction system if it is established in the verification step that the at least one token reference of the received registration request is not stored in the token reference register.

The receiving step preferably takes place at an interface of the token reference register, preferably an interface of the verification unit of the token reference register.

A transaction system is a system in which at least two, preferably a plurality of subscriber units can exchange (transmit) tokens directly amongst one another. The transaction system is, for example, a payment transaction system for exchanging monetary values in the form of payment tokens.

A token is a data set of a transaction system that can be directly exchanged between subscriber units. With knowledge of the token, the receiving subscriber unit is in possession of the token value that the token represents. With the exchange, the token accordingly automatically changes owner. A token—a data set that can be transmitted independently of an account in a transaction topology—can be transmitted directly between the subscriber units, that is to say, in particular without a different unit of the transaction system being connected in between and/or having access to the token.

In one embodiment, the token is an electronic coin data set or payment token for exchanging monetary values between subscriber units. In colloquial terms, such a payment token is also referred to as a “digital coin” or “electronic coin” and represents cash in electronic form.

Each token in the transaction system is a data set comprising at least two token elements.

A first token element of each token of the transaction system is a token value, for example an asset value, an asset, a commodity, and/or a monetary value.

A second token element of each token of the transaction system is a private part of a token-individual key pair. This private part is a secret in the transaction system and is not published and may not be used multiple times. The creation of the private part must not be predictable. This private part can be a random number. The random number is preferably the result of a true random generator.

The token is formed from the token value (first token element) and the private part. This formation is preferably the chaining (concatenation) of these two token elements. Any other type of chaining of these two token elements is not excluded according to the invention and includes, for example, back-end attachment, introduction into a TLV data structure and/or logical chaining.

Anyone who is in possession of a token or has unrestricted access to the token with their token elements can exchange this token with another subscriber unit. The possession of the token with its at least two token elements (token value and private part of the token-individual key pair) is thus equivalent to the possession of the value representing the token.

A token reference is assigned to each token in the transaction system. This assignment is unique, i.e. one token reference is assigned to precisely one token, and each token reference is assigned precisely one token. The token reference is a public data set which is stored, such that it can be reviewed, in a memory unit of the token reference register of the transaction system for each subscriber unit.

Both the token and the token reference are unique. Due to the unique assignment, a 1-to-1 relationship exists between the token and the token reference.

Each token reference in the transaction system is a data set comprising at least two token reference elements.

A first token reference element of each token reference is the token value of the token uniquely assigned to the token reference. The token value of the token is thus identical to the token value of the assigned token reference. For example, the token value of the token reference is a copy of the token value of the assigned token.

A second token element of each token reference of the transaction system is a public part of the token-individual key pair. Together with the private part of the token, this public part of the token reference forms the token-individual key pair. The public part is obtained by applying a cryptographic function to the private part.

This cryptographic function is a one-way function. This cryptographic function is accordingly a mathematical function which can be calculated “easily” in terms of complexity theory, but is “difficult” up to virtually impossible to reverse. In this case, a one-way function also denotes a function for which, hitherto, a reversal that is practically executable within a reasonable time and with reasonable effort has not been known. Preferably, a one-way function is used which operates on a group in which the discrete logarithm problem is difficult to resolve, such as a cryptographic method analogous to an elliptical curve encryption, for short ECC, from a private key of a corresponding cryptography method. The reverse function, i.e. the creation of a token (or the part of the electronic coin data set) from a token reference, is very time-consuming here.

The (mere) knowledge or the possession of a token reference does not afford the right to use/transmit/output the token value (token reference element). This represents a substantial difference between the token reference and the token and is a core of the present invention.

After the cryptographic function has been applied to the private part of the token-individual key pair, the public part of the token-individual key pair is obtained as the second token reference element.

The token reference is formed from the token value (first token reference element) and the public part. This formation is preferably the linking (concatenation) of these two token reference elements. Any other type of chaining of these two token reference elements is not excluded according to the invention and includes, for example, back-end attachment, introduction into a TLV data structure and/or logical chaining.

A token reference can preferably be created by an electronic wallet of a subscriber unit. For this purpose, the subscriber unit must have knowledge of the token with its token elements. The token reference can be created by an electronic wallet of a subscriber unit that wishes to send the token. Alternatively, the token reference can be created by an electronic wallet of a subscriber unit which has received the token.

The use of a token reference is not comparable to the use of addresses of subscriber units in a blockchain-based transaction system, among other things because no addresses of the subscriber units are used in the token reference register according to the invention in order to prevent the possibility of the tokens being tracked.

The method for registering provides a receiving step in order to receive a token reference in a token reference register within the scope of a registration request. For example, the registration request is sent by a subscriber unit of the transaction system or a token issuer of the transaction system.

The token reference register is a unit of the transaction register that stores the token references, whereby the associated tokens are registered. This register can be a central database or memory unit. This register can be a decentralized ledger, for example in a blockchain topology. The token reference register can maintain a history of the token references and/or the registration requests.

The received registration request is verified by a verification unit in the token reference register. In this case, it is verified whether the at least one token reference of the received registration request is already stored in the token reference register.

In the token reference register, a token reference is stored only once. Since a token reference of a token is present only once in the transaction system, it can be established by the verification step whether an attempt has been made to output a token several times.

In one embodiment, in the verification step using the verification unit of the token reference register, it is also established whether the token reference can be assigned to a token in the received registration request. For this purpose, the token reference or a derivation of the token reference or a history of the token reference must be stored in the token reference register which can be assigned to the token reference of the received registration request.

In one embodiment, in the verification step, it is established whether the received registration request is syntactically correct. For example, it is thus checked whether the registration request is plausible, whether a command type was correctly indicated in the registration request, whether the token which is uniquely assigned to the token reference is actually present (can exist); and/or whether a difference formation of token values in the registration request matches a command type specified in the registration request.

In one embodiment, in the verification step, it is established whether a signature of the registration request is correct.

In one embodiment, in the verification step, it is also determined whether a sum of token values of all token references within the registration request is zero. In this case, input token values and output token values of the registration request are summed. In the case of registration requests originating from subscriber units, a sum of all token values of the registration request must give zero. If the sum does not give zero, a token value will have additionally been created inadmissibly in the transaction system or a token value will have been destroyed from the transaction system. A fraudulent attempt with a non-existing token or a token generated inadmissibly can thus be detected more easily. Until now, complex range references (zero-knowledge proofs, ZKP) have been necessary, which can be omitted by this method.

The received token reference is stored in a memory unit of the token reference register. The memory is used to register in the transaction system the token uniquely assigned to the received token reference. The storage process takes place only if it is determined in the verification step that the at least one token reference of the received registration request is not stored in the token reference register.

The basic principle of registering a token is accordingly that a received registration request is verified to determine whether the token reference assigned to the token is already known in the token reference register. If the token reference is already known, it will not be stored again. If the token reference is not known, it will be entered (stored) into the token reference register in order to be available in the transaction system for future verification and checking steps.

In one embodiment, the public key part of the token-individual key pair of the token reference is at the same time a database index of a database of the token reference register. The database index in this case is an index structure separated from the data structure in the token reference register, which accelerates the searching and sorting for token references. It can be a collection of pointers (references) which define an order relation to one or more entries in the token reference register. By using the public key part as an index, the verification is greatly simplified. No check of duplicates is thus necessary anymore, because in the token reference register the uniqueness of the index is already checked.

In one embodiment, the received registration request is signed with the private part of the token-individual key pair in order to be able to check or verify an assignment of the token reference to the token. If the verification in the verification step is successful, i.e. the signature can be verified, then the sender of the registration request must be in possession of the token or have the knowledge of the token. A fraudulent attempt with a non-existing token or a token generated inadmissibly can thus be detected.

In one embodiment, the token reference register has one or more memory units for storing token references for registering the tokens in the transaction system. This (these) memory unit(s) can be maintained as a central database of the transaction system. The use of a plurality of memory units enables a parallel processing of registration requests and accelerates registering in the transaction system.

In one embodiment, the token reference register has one or more verification units for verifying received registration requests. The use of a plurality of verification units enables a parallel processing of registration requests and accelerates registration in the transaction system.

This (these) verification unit(s) compare(s), for example, a command type of the received registration request with the token values of the received registration request. If a command type is expected that no token values are added to the transaction system or are to be subtracted from the transaction system, a check will be made as to whether this is also maintained with the token values of the received token references. In the case of failed verification, a fraudulent event is detected and a registration is prevented.

In one embodiment, the token reference register has one (or more) check units for checking the received registration request. The check unit checks the registration request, in particular for syntactic correctness of the registration request, admissibility of a command type of the registration request, sum of the token values in the registration request (must be zero) and/or signature of the registration request before it is verified by the verification unit. Only the contents of the registration request are checked by the check unit. This check therefore does not require access to the memory unit (or takes place without access to the memory unit). The checking steps carried out by a check unit no longer have to run the verification unit. The verification unit can thus be relieved.

In one embodiment, the token reference register has a total sum check unit for checking a total sum of token values of the token references of registered tokens. The total sum is preferably checked independently of the receipt of a registration request. It is checked, for example, at regular intervals or at random times or in an event-related manner. The total sum check unit determines a current total sum and compares the current total sum with a total token value. The total token value is not changed by registration requests from (normal) subscriber units. The total token value can change due to registration requests of the token issuer. The total token value is preferably changed on request of a new registration unit, via which only the token issuer can register new tokens or de-register registered tokens. A check unit can initiate the total token value check for a registration request. The validity of the token value can thus be checked to determine whether a new token value was generated inadmissibly. By checking the total token value by forming the total sum, all old registration requests are checked indirectly and old registration requests and their success can also be checked in a targeted manner.

A registration request history could be used to process registration requests sent in duplicate without burdening the memory unit of the token reference register.

In one embodiment, the token reference register has a new registration unit in order to register token references to newly created tokens (=new tokens) or deleted tokens (deactivated tokens) of a token issuer. These newly created tokens and these deleted tokens can be entered into the token reference register via this new registration unit of the token reference register. With the new registration unit, a reference value relating to the total token value of the tokens located in the transaction system can be updated on the basis of the created and/or deleted tokens in the token reference register (for example in a check unit of the total token value). If, for example, a new token is generated, then its token value will be added to the total token value. If, for example, a token is deleted, then its token value will be subtracted from the total token value.

In one embodiment, the token reference has at least one count value as a further token reference element. The count value can be a further token element. The count value can represent, for example, the number of off-line transactions of the token. An off-line transaction in this case is a direct transaction between subscriber units in the transaction system for transmitting tokens, without the token being registered in the token reference register. The count value increases (increments) with each off-line transaction. It can be provided, in a manner determined by the system, that tokens must be registered automatically in the token reference register when a predefined threshold value for the count value is exceeded.

In one embodiment, the token reference has at least one identity of a subscriber unit or of an owner of the subscriber unit as a further token reference element. The identity can be a further token element. This identity serves, for example, in the checking step to validate or verify the token reference. The anonymity in the transaction system is thus canceled and a fraudulent event is discovered more quickly.

In one embodiment, the token reference has at least one pseudonym of a subscriber unit or of an owner of the subscriber unit as a further token reference element. The pseudonym can be a further token element. This pseudonym serves, for example, in the checking step to validate or verify the token reference. The anonymity in the transaction system is thus not canceled and a fraudulent event is nevertheless discovered more quickly when a unit of the transaction system resolves the pseudonym.

In order to create the token reference, each further token reference element can be added by a chaining (concatenation) with the first and/or second token reference elements.

In one embodiment, the registration request relates to a modification—in particular a splitting, merging or switching—of at least one previously registered token and preferably comprises at least the token reference of the at least one previously registered token and the at least one token reference of the token to be registered, which is the modification of the previously registered token.

In one embodiment, the registration request relates to a splitting of a token, and preferably the registration request comprises a token reference of the token to be split and a token reference of each of the (at least two) split tokens. The token references contained in the registration request can be joined together by chaining (concatenation). The split is a possibility of modification on a token with which a token value of a token can be split into at least two (smaller) token values. It is thus possible to reduce the token value and to react to a transaction request more accurately in terms of token value. The split token is thus invalid and the (at least two) split tokens are registered in the token reference register in order to be checked in the transaction system.

Alternatively or additionally, it is provided for the split that the token value of the token to be split is split into at least one first token value and into one second token value. The split can take place symmetrically, so that the split token values are of equal size. The split can take place asymmetrically, so that the split token values are different.

Alternatively or additionally, the following steps are provided during the split: creating a new private part of a token-individual key pair for a first split token; applying a cryptographic function to obtain a corresponding public part of the token-individual key pair for the first split tokens; creating a new private part of a token-individual key pair for a second split token; applying a cryptographic function to obtain a corresponding public part of the token-individual key pair for the second split token; splitting the token value into a first token part value and into a second token part value, taking into account that the sum of the first token part value and the second token part value corresponds to the token value of the token to be split; creating a token reference for the first split token comprising the first token part value and the public part of the token-individual key pair of the first split token; creating a token reference for the second split token comprising the second token part value and the public part of the token-individual key pair of the second split token; and creating the registration request using the token reference of the token to be split, the token reference for the first split token and the token reference for the second split token.

In one embodiment, the registration request relates to a switching of a token and preferably the registration request has a token reference of the token to be switched. The switching of the token is a further modification possibility. The token references contained in the registration request can be joined together by chaining (concatenation). If a token is transmitted by a subscriber unit directly to another subscriber unit, for example if the monetary value is to be transmitted as a token value within the scope of a payment transaction, the receiving subscriber unit can now have the token value re-registered to itself. The switching is thus registered in the token reference register.

When a token is transmitted between two subscriber units, these two subscriber units will simultaneously have knowledge of the token. In order to prevent the sending subscriber unit from also using the token in another (third) subscriber unit (so-called multiple output of the token), a switch of the transmitted token from the first subscriber unit to the second subscriber unit is preferably carried out. The switch can preferably take place automatically when a token is received in the second subscriber unit.

Alternatively or additionally, the following steps are provided during the switch: creating a new private part of a token-individual key pair; applying a cryptographic function to obtain a corresponding public part of the token-individual key pair; creating the registration request using the token reference for the token to be switched and the public part of the token-individual key pair for the switched token.

The token value of the token to be switched corresponds to the token value of the switched token. During the switch, a token having the same token value but a new private part is accordingly registered in the token reference register.

In one embodiment, the registration request relates to a merging of at least two tokens, and the registration request preferably has a token reference of the merged token and a token reference of each of the tokens to be merged. The token references contained in the registration request can be joined together by chaining (concatenation). The connection (=merge) is a possibility for modification at a token, with which two token values are merged, that is to say, linked to one another. It is thus possible to fuse two token values into one token value in order to react to a transaction request accurately in terms of token value. The tokens to be connected are thus invalid and the connected token is registered in the token reference register in order to be checkable in the transaction system.

Alternatively or additionally, the following steps are provided during the merging: creating a new private part of a token-individual key pair; applying a cryptographic function for obtaining a corresponding public part of the token-individual key pair for the merged tokens; calculating the token value for the merged token by forming the sum of the respective token values of the at least two tokens; creating a token reference for the merged token comprising the calculated token value and the public part of the token-individual key pair for the merged token; and creating the registration request using each token reference of the tokens to be merged and the token reference for the merged token.

In one embodiment, a registration request is sent by a token issuer, wherein the registration request relates to a creation of a token or a deletion of a token.

In contrast to a subscriber unit, a token issuer is a privileged entity in the transaction system, which can be created by the tokens and deleted. A subscriber unit cannot create or delete tokens, it can only modify tokens (switch, split, merge).

The token is stored in a subscriber unit. The subscriber unit can have a plurality of tokens, for example the plurality of tokens can be stored in a data memory of the subscriber unit. The data memory can be, for example, internal, external or virtual. In one embodiment, a “merge” can automatically take place when a token is received, so that preferably only one (or a certain number of) tokens are stored in the subscriber unit.

The subscriber unit can be, for example, a mobile terminal, such as a smart phone, a tablet computer, a computer, a server or a machine. The subscriber unit may be a smart card that is introduced ready for operation in a terminal.

A secure element is set up as a subscriber unit of a transaction system
for the direct exchange of tokens with a further subscriber unit, wherein each token of the transaction system comprises at least one token value and a private part of a token-individual key pair as token elements,
for creating a modified token from an existing token to be modified, wherein a token reference uniquely assigned to the modified token of the transaction system comprises at least the token value of the token and a public part of the token-individual key pair as token reference elements, wherein the public part of the token-individual key pair is obtained by applying a cryptographic one-way function to the private part of the token-individual key pair of the token, and
for providing a registration request to a token reference register of the transaction system, wherein the registration request has at least the token reference uniquely assigned to the token of the transaction system.

The data memory is, for example, a wallet memory of an electronic wallet. The electronic wallet is, for example, a software application which is stored executably in a subscriber unit. The electronic wallet can enable the subscriber unit to participate in the transaction system. The electronic wallet can thus generate a registration request in order to register a token in a token reference register. In addition, the electronic wallet can carry out modifications (switching, merging, splitting) on a token and can generate the registration requests that are possibly necessary and transmit them to the token reference register. In addition, the electronic wallet can transmit tokens to another wallet (in another subscriber unit).

A transaction in the transaction system is preferably atomic.

The token reference register accordingly has knowledge about token references of tokens of the transaction system and preferably also maintains the processing operations or modifications to the token (token history). The transactions with the token are not registered in the token reference register and take place directly between subscriber units of the transaction system in a direct transaction layer of the transaction system.

According to the invention, a token reference register for a transaction system is provided which is set up to carry out the method steps according to the method described above.

In one embodiment, the token reference register comprises: at least one memory unit for storing token references for registering tokens in the transaction system; a check unit for checking received registration requests, at least one verification unit for verifying whether a token reference of a received registration request is stored in the token reference register and/or a new registration unit for registering tokens newly generated by a token issuer or a token deleted by a token issuer.

According to the invention, a transaction system is provided which comprises: a register layer with a token reference register of the preceding type for registering token references, and a direct transaction layer with a plurality of subscriber units, set up to directly exchange tokens among one another.

According to the invention, a two-layer transaction system is thus provided from a direct transaction layer for the direct exchange of tokens and a register layer. In the register layer, no transactions are logged, but only token references are stored, and modifications to tokens are stored via correspondingly adapted token references for the purpose of verifying the validity of tokens. The anonymity of the subscribers of the transaction system is thus ensured. On request, the token reference register provides information about the token references which are uniquely associated with the tokens of the transaction system in order, for example, to prevent a multiple output of the same token or to verify the authenticity of the token.

The memory unit of the token reference register preferably only stores token references of tokens actually present in the transaction system. Once a token is modified and a corresponding (modified) token reference is to be registered, the (old) token references become invalid and (only) the modified token references are stored in the memory unit.

The terminal can thus transmit electronic coin data sets to another terminal in the direct payment transaction layer without connection to the monitoring entity, in particular if the terminal is off-line, i.e. there is no communication connection to the monitoring entity.

A subscriber unit can, in the present case, be a secure element which has secure access to tokens in a token memory. The secure element is, for example, introduced ready for operation in a terminal. The secure element and/or the terminal have a special computer program product (electronic wallet), in particular in the form of a secured runtime environment within an operating system of a terminal (trusted execution environment, or TEE), which is stored on a data memory, for example of a mobile terminal, a machine, preferably an ATM. Alternatively, the secure element is designed, for example, as special hardware, in particular in the form of a secured hardware platform module (trusted platform module, or TPM), or as an embedded security module, eUICC, eSIM. The secure element provides a trusted environment.

The communication between the terminal and the secure element as a subscriber unit can take place by means of APDU. The communication between terminal and token reference register or issuer unit can take place by means of API calls. The terminal is only a protocol translator and does not change the registration requests.

The communication between two subscriber units for exchanging tokens can take place wirelessly or by wire, or for example also on an optical path, preferably via QR code or barcode, and can be designed as a secure channel. The exchange of tokens is, for example, additionally protected by cryptographic keys, for example a session key negotiated for a token exchange or on the basis of a subscriber-unit-individual key pair.

### BRIEF DESCRIPTION OF THE DRAWINGS

The invention and further embodiments and advantages of the invention will be explained in more detail below with reference to figures, wherein the figures merely describe exemplary embodiments of the invention. Identical components in the figures are provided with the same reference numbers. The figures are not to be considered true to scale; individual elements of the figures may be illustrated excessively large or excessively simplified.

FIG. 1 shows an exemplary embodiment of a transaction system according to the invention;

FIG. 2 shows an exemplary embodiment of a token reference register according to the invention;

FIG. 3a shows an overview of commands according to the invention for tokens;

FIG. 3b shows an overview of signed registration requests according to the invention for the commands according to the invention;

FIG. 4 shows an exemplary embodiment of a flowchart of a method according to the invention for creating and registering a token and an overview of the command details in dependence on the transaction layer;

FIG. 5 shows an exemplary embodiment of a flowchart of a method according to the invention for deleting a token and registration;

FIG. 6 shows an exemplary embodiment of a flowchart of a method according to the invention for splitting and registering a token and an overview of the command details in dependence on the transaction layer;

FIG. 7 shows an exemplary embodiment of a flowchart of a method according to the invention for merging and registering a token and an overview of the command details in dependence on the transaction layer;

FIG. 8 shows an exemplary embodiment of a flowchart of a method according to the invention for switching and registering a token and an overview of the command details in dependence on the transaction layer; and

FIG. 9 shows a further exemplary embodiment of a token reference register according to the invention.

### DETAILED DESCRIPTION OF VARIOUS EMBODIMENTS

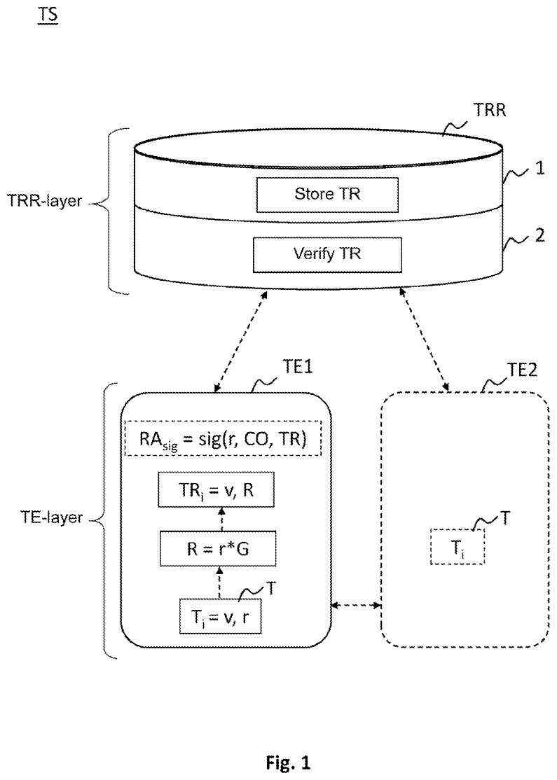

FIG. 1 shows an exemplary embodiment of a transaction system TS according to the invention. The transaction system TS comprises a register layer, TRR layer, in which a token reference register TRR is arranged. The TS also comprises a direct transaction layer TE layer in which a plurality of subscriber units TE can be provided, representatively with two subscriber units TE1, TE2.

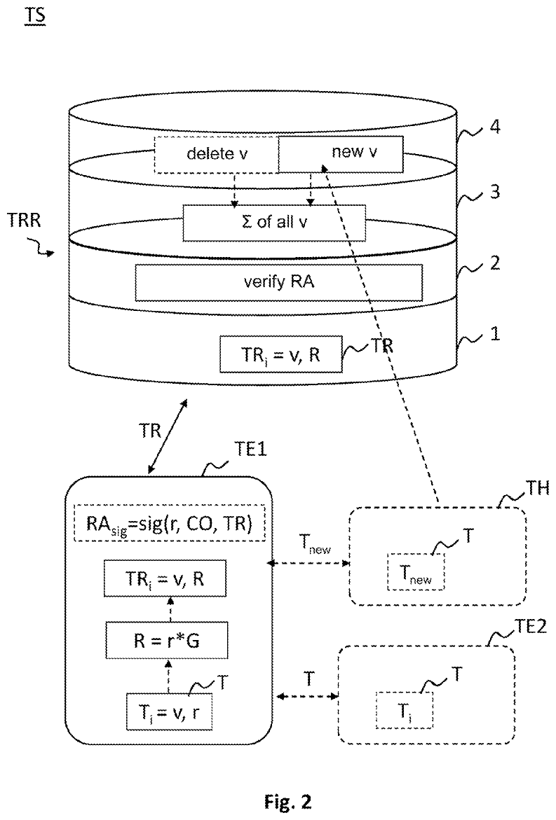

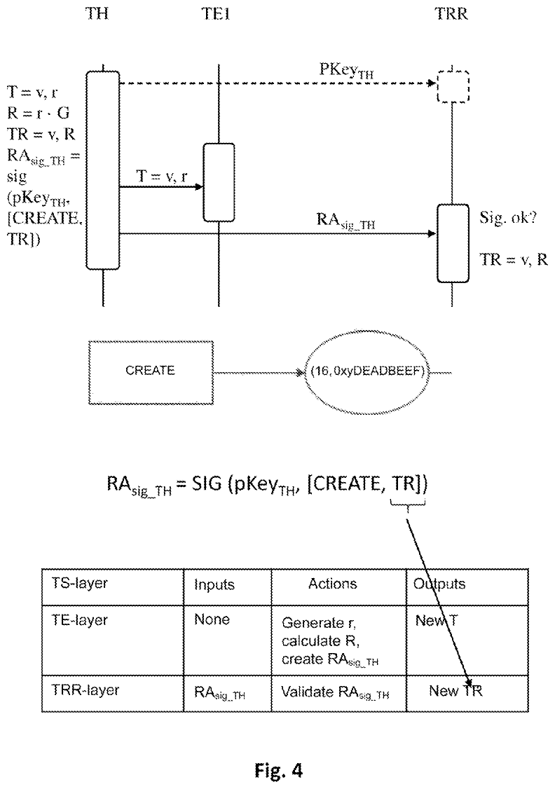

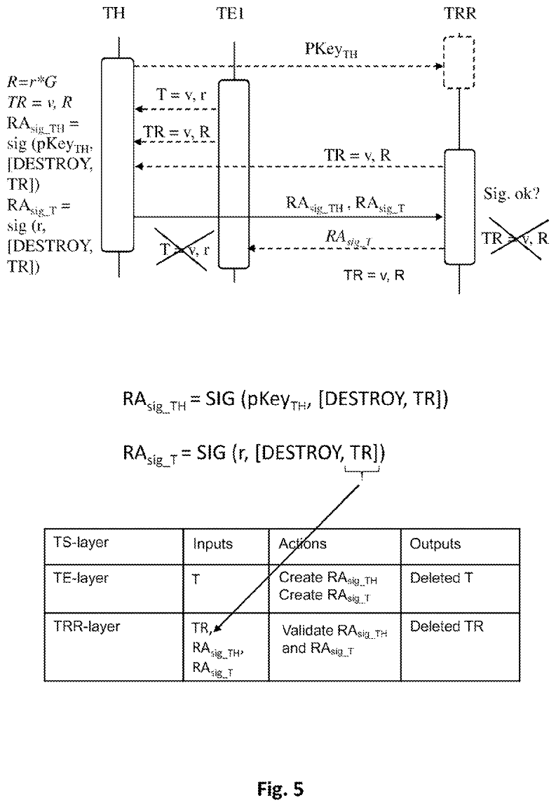

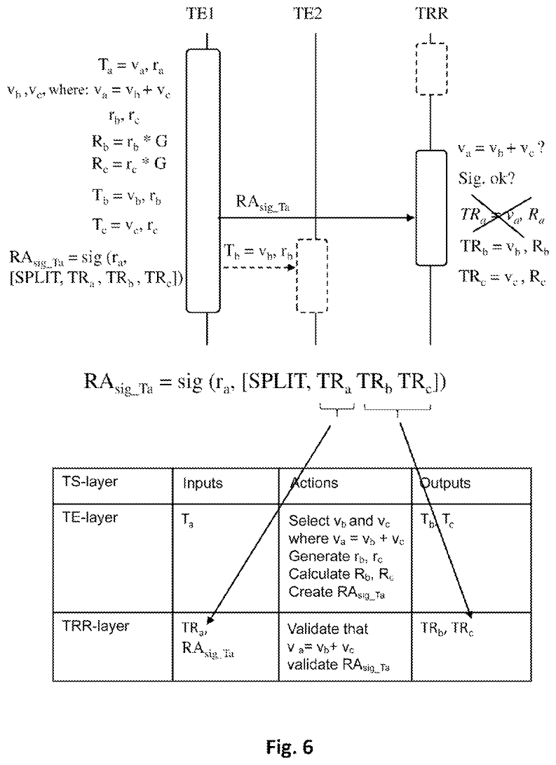

The subscriber units TE of the transaction system TS are set up to exchange tokens T directly amongst one another. In the case of FIG. 1, the tokens are payment tokens, which are also referred to as digital coins. Each token T is generated by a token issuer TH (not shown in FIG. 1; see FIG. 2). Each token T can be split, merged or switched by each subscriber unit TE (see FIGS. 6 to 8) and can be generated by the token issuer TH (see FIG. 4) and also deleted (see FIG. 5). A token issuer TH is, for example, a central bank.

A token T is uniquely represented by a token value v and a random number r as token elements in the transaction system TS. The token value v can be given in a value range from 1 to 2³¹−1. The random number r can be a number in the range from 0 to 2²⁵⁶−1, i.e. the order of an elliptical curve, for example secp256r1.

The random number r is a private part of a token-individual key pair. The random number r is unique and secret in the transaction system TS and cannot be published or re-used. The creation of the random number r may be unpredictable.

For example, the token value v is a 32-bit token element of the integer type. For example, the random number r is a 32-byte token element of the integer type. A subscriber unit TE has exclusive access to this token memory or comprises this token memory in a data memory of the subscriber unit TE.

A token can be stored as a TLV-encoded data set in a token memory and then has a unique tag and length information, for example in the following format.

| | Day | | Token | Random |
|---|---|---|---|---|
| Name | (hex) | Length | value v | number r |
| TLV-encoded token | 42 | 1 byte | 4 bytes | 32 bytes |

An example of a TLV-encoded token in hexadecimal form is shown below:
42 24 00 00 40 00 00 01 02 03 04 05 06 07 08 09 0A OB 0C 0D 0E 0F 10 11 12 13 14 15 16 17 18 19 1A 1B 1C 1D 1E 1F
and is interpreted as follows:
“42” is the tag for identifying the TLV-encoded token T;
“24” specifies the length, i.e. in this case that it is a 36-byte data set;
“0000 40 00” is the token value (integer) v=16384 and is accordingly € 163.84;
“00 01 02 03 04 05 06 07 08 09 . . . 1D 1E 1F” is the random number r as an integer.

A token reference TR can be stored in the token reference register TRR for each token T. The token reference TR comprises the token value v of the assigned token T and a public part R of the token-individual key pair. The token reference TR of the token T can be viewed at any time in the register TRR of the transaction system TS. The token value v of a token T is thus disclosed by the token reference register TRR.

The public part R of the token-individual key pair is created by applying a cryptographic function to the private part r of the token-individual key pair. This function is difficult to reverse and thus gives the transaction system TS the available security. R=r*G, wherein G can, for example, be a global parameter of the transaction system TS, for example a generator point of an elliptical curve, here the secp256r1 curve.

The token reference TR is then formed by the token value v of the token and the public part R of the key pair. The token reference TR is thus the chaining or concatenation of token value v and public part R.

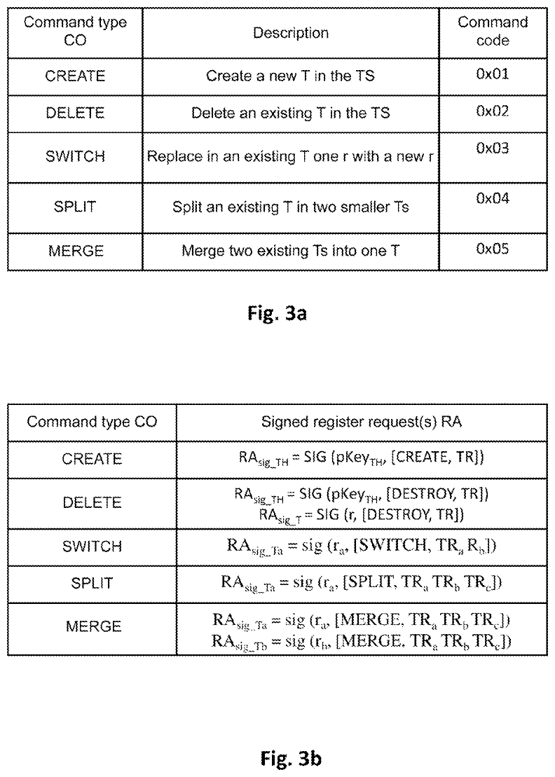

This token reference TR can be sent as a registration request RA, possibly together with a command (see overview in FIGS. 3a and 3b) with respect to the token T to the token reference register TRR.

In addition, the registration request RA can be signed with the private part r of the token-individual key pair. The signing makes it possible to verify whether the transmitter of the token reference TR was in possession of the token T, whereby the security in the transaction system TS is further increased.

In the subscriber unit TE, the signed registration request RAsig is stored as a so-called PROOF, for example in the following format:

| Type | Day (hex) | Length | Data |
|---|---|---|---|
| PROOF | 4A | N bytes | |

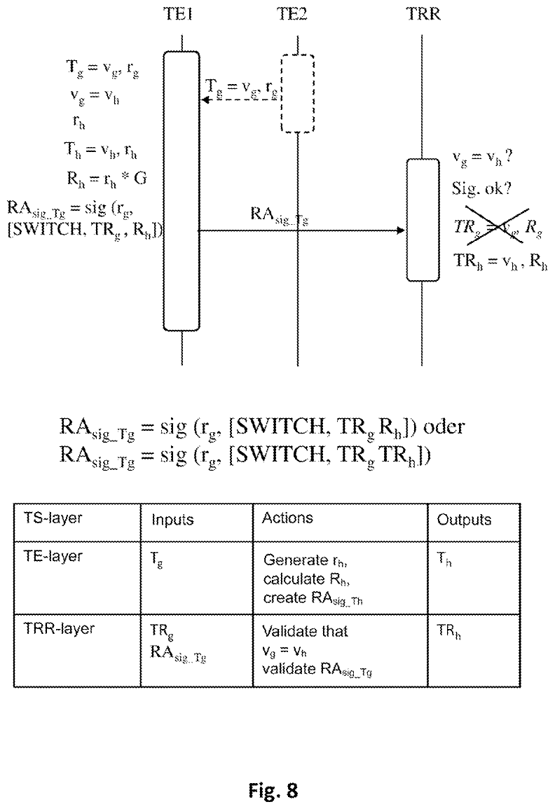

An example of a PROOF (=RA_{sig}) in hexadecimal form is shown below:
4A 81 8F 03 11 12 13 14 15 16 17 18 19 1A 1B 1C 1D 1E 1F 20 21 22 23 24 25 26 27 28 29 2A 2B 2C 2D 2E 2F 30 31 32 33 34 35 36 37 38 39 3A 3B 3C 3D 3E 3F 40 41 42 43 44 45 46 47 48 49 4A 4B 4C 4D 4E 4F 50 51 52 53 54 55 56 30 46 11 12 13 14 15 16 17 18 19 1A 1B 1C 1D 1E 1F 20 21 22 23 24 25 26 27 28 29 2A 2B 2C 2D 2E 2F 30 31 32 33 34 35 36 37 38 39 3A 3B 3C 3D 3E 3F 40 41 42 43 44 45 46 47 48 49 4A 4B 4C 4D 4E 4F 50 51 52 53 54 55 56
and is interpreted as follows (see also FIG. 8 regarding the structure of a switch registration request):
“4A” is the day for identification of the TLV-proof RA_{sig_Th};
“81 8F” gives the length;
“03” indicates that this is a switch (=SWITCH) registration request;
“11 12 13 14” is the token value v_{g};
“15 16 17 18 19 1A 1B 1C 1D 1E 1F 20 21 22 23 24 25 26 27 28 29 2A 2B 2C 2D 2E 2F 30 31 32 33 34 35” is the public part R_{g};
“36 37 38 39 3A 3B 3C 3D 3E 3F 40 41 42 43 44 45 46 47 48 49 4A 4B 4C 4D 4E 4F 50 51 52 53 54 55 56” is the public part Rₕ;
“30 46 11 12 13 14 15 16 17 18 19 1A 1B 1C 1D 1E 1F 20 21 22 23 24 25 26 27 28 29 2A 2B 2C 2D 2E 2F 30 31 32 33 34 35 36 37 38 39 3A 3B 3C 3D 3E 3F 40 41 42 43 44 45 46 47 48 49 4A 4B 4C 4D 4E 4F 50 51 52 53 54 55 56” is the signature as X690 sequence.

This registration request RA can be sent to the token reference register TRR. This registration request RA is received in the token reference register TRR. After checking the registration request RA by the token reference register TRR, the token reference TR is stored in the token reference register TRR, whereby the token T is registered in the transaction system TS.

This token reference TR is uniquely assigned to the token T and is used to register the token T in the transaction system TS. The token reference TR is accordingly the public representation of the token T from the direct transaction layer TE layer. The sole knowledge or only the possession of the token reference TR does not allow the token T to be transmitted and is not equivalent to the TE being in possession of the token T. The token reference TR serves to prevent multiple output attempts and checks whether token values v have been generated inadmissibly. For this reason, the token reference TR and possibly the history via the tokens T and the corresponding registration requests RA of subscriber units TE are stored in the token reference register TRR.

The tokens T are stored, for example, in electronic wallets of a TE. These wallets are, for example, software applications within the subscriber units TE or a terminal in which the TE is introduced ready for operation. A wallet can be set up as an application on a smart phone, a smart card, or a payment terminal. The wallet serves to securely manage tokens T of the TE, to create token references TR, to modify tokens T and/or to exchange tokens T. Wallets serve to communicate with the token reference register TRR, to generate registration requests RA to the token reference register TRR and/or to carry out transactions of tokens T relative to a subscriber unit TE.

For a transaction with a subscriber unit TE, it is not necessary for there to be a communication link to the token reference register TRR of the transaction system TS. The transaction system TS is set up to carry out a transaction off-line, i.e. without a communication link to the token reference register TRR. A corresponding registration of tokens T can therefore be temporally downstream of a transmission of the token T to a subscriber unit TE.

The token reference register TRR is a unit of the transaction system TS and is either a central register or a central database of the transaction system TS or a decentralized register or a decentralized database (DLT) of the transaction system TS.

The transmission of a token reference TR from a secure element as subscriber unit, in which an electronic wallet is present, takes place, for example, as APDU command(s) to a terminal (smart phone) of the subscriber, which terminal preferably comprises the secure element. An APDU is a combined command/data block of a connection protocol between the secure element and the terminal. The structure of the APDU is defined by the ISO 7816-4 standard. The terminal device extracts APDU command(s) and transmits the data in API calls to the token reference register TRR, where HTTP codes are implemented.

FIG. 2 shows an exemplary embodiment of a token reference register TRR of the invention.

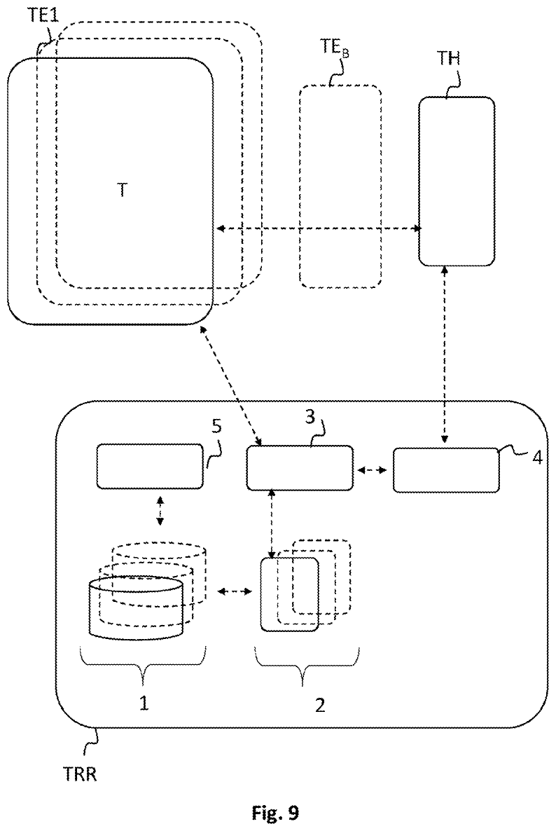

The token reference register TRR manages in particular the storage location for the token references TR, here as a database 1 as an example of a memory unit in the token reference register TRR. As a representative, the TR for the token T of the subscriber unit TEL is entered in the database 1. This database 1 can consist of a combination of many databases (see also FIG. 9), which are networked with one another. For simple finding of a token reference TR, the public part R of the token reference TR is simultaneously a database index in the database 1, since both an index of a database and a public part R of a token reference TR must be unique in the transaction system TS.

In addition, the token reference register TRR will comprise at least one verification unit 2. The verification unit 2 of the token reference register TRR verifies registration requests RA. A syntactic correctness or also the correct indication of a command in the registration request RA can be verified here. A history of old (past) registration requests RA regarding a token T can also be verified in this case. The separation of this verification unit 2 from the database 1 distributes the tasks of storing and verification (or checking) and increases the speed in the token reference register TRR.

In addition, the token reference register TRR can comprise an optional check unit 3 which checks the registration request RA, in particular before the verification unit 2 verifies with the aid of the contents of the database 1. The check unit 3 checks the registration request itself, i.e. only its content. For example, the syntactic correctness, sum of the token values in the registration request (gives zero), command type, and/or a signature of the registration request are checked.

In addition, it could optionally request a check of a total token value Σ in the transaction system TS for the registration request. A total token value check unit (5 in FIG. 9) can check whether the current total sum of the token values of token references of registered tokens in the token reference register TRR corresponds to the total token value. Due to the registration request of (normal) subscriber units TE1, the total token value of the registered tokens must not change. If this were the case, a new token value v would be created or an existing token value v would be destroyed. These actions may only be performed by privileged units, such as in the present case an issuing entity TH, in the transaction system TS. If such a change in the total sum of the token values is detected by a token reference TR of a subscriber unit TE, a fraudulent or fault event can then be assumed. An illegal generation of token values v can thus be discovered and prevented very easily.

The check of the total token value represents a further security concept in the transaction system TS.

In addition, the token reference register TRR can comprise a new registration unit 4, into which newly generated token references TR of a token issuer TH are registered for the first time or de-registered with token references TR to be deleted. A functional separation between token references TR of privileged subscribers, such as a token issuer TH, and token references TR of unprivileged subscribers, such as the subscriber units TE, is thus achieved. The token values v of newly generated token references TR or token references TR to be deleted have a direct influence on a change in the total token value, which is monitored in the total token value check unit.

A registration request RA is preferably signed with the private part r. With the signature a syntactic authenticity of the command can easily be checked by the receiver (TRR or TE). This test preferably takes place in the check unit 3 or the verification unit 2. In addition, a registration request RA can, for example, be validated syntactically by checking the signature and/or the token reference TR.

Even when a signature can be checked in a subscriber unit TE, it is thereby not ensured that no multiple output of the same token T has been attempted. The registration in the token reference register TRR is therefore provided. In addition, a secure hardware platform is kept available by the subscriber units TE. With available connection to the token reference register TRR, the token references TR are transmitted and the multiple output attempt can be discovered in the token reference register TRR.

If a token reference TR is not yet known in the token reference register TRR, it will be added.

FIG. 3a shows an overview of commands CO that can be performed on a token T. The commands CO can be modifications to an existing token T, for example “Switch”, “Split” or “Merge”. The commands CO can also relate to the creation (=Create) of a token T or the deletion (Destroy) of existing tokens T. In FIG. 3a, command codes are specified by way of example (0x01 to 0x05), which can then be part of a registration request RA.

FIG. 3b shows an overview of commands CO and their signed registration request syntax RA. In this case, input tokens T and input token references TR are “consumed” per command CO. In this case, output tokens T and output token references TR are “created” per command CO.

A command CO has the basic structure of the following three elements: command type, input token reference(s), output token reference(s).

Each command has a characteristic number of input token reference(s) (“inputs”) and output token reference(s) (“outputs”), which are explained and shown in greater detail in FIGS. 4 to 8.

It should be noted that, for the commands CO “split”, “switch” and “merge”, the difference of the token values v of all participating tokens T or token references TR must give the value “zero”. In other words, these commands CO “split”, “switch” and “merge” do not create any token values v and do not destroy any token values v. This can be detected on the basis of the command type CO itself or can also be checked by the check unit 3 of the token reference register TRR and is a check criterion for a registration request RA.

It is also to be noted that a difference of the token values v of the participating token T or token references TR is allowed only for the commands CO “create” and “destroy”, but only at the level of the token value v of the token T and not beyond.

Each registration request can be signed in order to be able to check that the transmitter of the token reference TR is also in possession of the associated token T. An ECDSA scheme can be applied as a signature. The registration request RA is preferably signed with the private part r of the token T.

For signed registration requests of the command types CO “create” and “destroy”, a further signature of a token issuer TH is requested in order to ensure that these commands have been generated by a privileged unit of the transaction system TS.

FIG. 4 shows an exemplary embodiment of a flowchart of a method according to the invention for creating a token T and registering it in the TRR. In addition, the signed registration request RA_{sig} and the command structure is shown in tabular form both from the point of view of the TE layer and of the TR layer.

During creation, there is no input parameter in the TE layer. A random number r is generated in a privileged unit, here the token issuer TH. On the basis of the random number r, a public part R is calculated, as has been described above. IA token reference TR can thus be formed in the token issuer TH starting from the token value v and the public part R by concatenation of v and R.

A registration request RA consisting of the command “CREATE” or the command code according to FIG. 3a and the created token reference TR is signed in the token issuer TH. For this purpose, the private key pKey of the token issuer TH is used.

In the TE layer, the token T is output to the TE1. In the TRR layer, the signed registration request RA_{sig} is output to the TRR.

In the token reference register TRR, the signature of the registration request RA is checked with the public key PKey of the issuing entity TH. This public key PKey_{TH} is known across the transaction system or was made available to the token reference register TRR in advance. If the signature check is successful, then the token reference TR is entered into the token reference register TRR.

In one embodiment, the new registration unit 4 of the token reference register TRR increases by the token value v the total token value of the transaction system TS, in particular in a total token value check unit of the token reference register TRR.

FIG. 5 shows an exemplary embodiment of a flowchart of a method according to the invention for deleting a token T and registering the deleted T in the TRR. In addition, the signed registration requests RA_{sig_TH} and RA_{sig_T} required for this purpose and the command structure are shown in tabular form both from the point of view of the TE layer and the TR layer.

During deletion, as an input parameter in the TE layer of the token T to be deleted, and in the TRR layer the token reference TRR to be deleted and two signed registration requests RA_{sig_TH} and RA_{sig_T} are used.

The registration request RA consisting of the command “DESTROY” and the token reference TR to be deleted is signed once with the private key pKey of the token issuer TH.

A further registration request RA consisting of the command “DESTROY” and the token reference TR to be deleted is also signed with the private part r of the token T.

Both signed registration requests are sent to the token reference register TRR. In the token reference register TRR, the signature is checked with the public key of the issuing entity TH. This public key is known across a transaction system or was made available to the token reference register TRR in advance. In addition, the signature of the further registration request RA is checked with the public part of the token reference TR. If both signature checks are successful, then the token reference TR is deleted in the TRR or marked as deleted.

In one embodiment, the total token value of the transaction system TS is reduced in a total token value check unit of the token reference register TRR by the token value v by the new registration unit 4 of the token reference register TRR.

The token reference register TRR or the token issuer TH also causes the token T to be deleted in the subscriber unit TE1.

FIG. 6 shows an exemplary embodiment of a flowchart of a method according to the invention for splitting a token Tₐ and registering the split tokens T_{b} T_{c} in the token reference register TRR. In addition, the signed registration request RA_{sig_Ta} required for this purpose as well as the command structure are shown in tabular form both from the point of view of the TE layer and the TR layer.

In the TE layer, a first random number r_{b} and a second random number r_{c} are generated by the TE1. Based thereon, a public part R_{b} and R_{c} is then generated in each case. The token Tₐ to be split is available in the TE layer as input parameters. The token value vₐ is split in the TE layer into a first token part value v_{b} and a second token part value v_{c}. The sum of token part value v_{b} and token part value v_{c} has to give the token value vₐ. This ensures that no new token value v is created or no token value v is destroyed.

The token references TR_{b} and TR_{C} are then created by the TE1. The registration request RA then contains the command “SPLIT” or the command code shown for this in FIG. 3a, the input token reference TRₐ and the output token references TR_{b} and TR_{C}. This registration request RA is signed with the random number rₐ of the token Tₐ. The signed registration request RA_{sig_Ta} is sent from the TE1 to the token reference register TRR. There, the signature is checked and the sum of v_{b} and v_{c} is formed and compared with the token value vₐ. If vₐ=v_{b}+v_{c} and the signature check is successful, then the token reference TRₐ in the token reference register TRR will be deleted or marked as deleted, and the token references TR_{b} and TR_{c} entered in the token reference register TRR.

In one embodiment, in the token reference register TRR in (the verification unit 2 or) the check unit 3, the token value difference of the input token reference TRₐ and the output token references TR_{b} and TR_{c} is formed and checked; this difference being zero. If the difference is not zero, a token value v will have been generated or destroyed inadmissibly.

In addition, theoretically, the total token value of the transaction system TS could also be checked by the check unit 3 of the token reference register TRR (by means of the total token value check unit 5) before or after the registration of the token references TR_{b} and TR_{c}. The total token value v in the total token value check unit 5 must not have changed and must correspond to the value before processing of the registration request in the token reference register TRR.

The split token T_{b} (or T_{c}) (which was temporarily transmitted from TE1 to TE2) can now be checked for validity by the subscriber unit TE2 in the TRR.

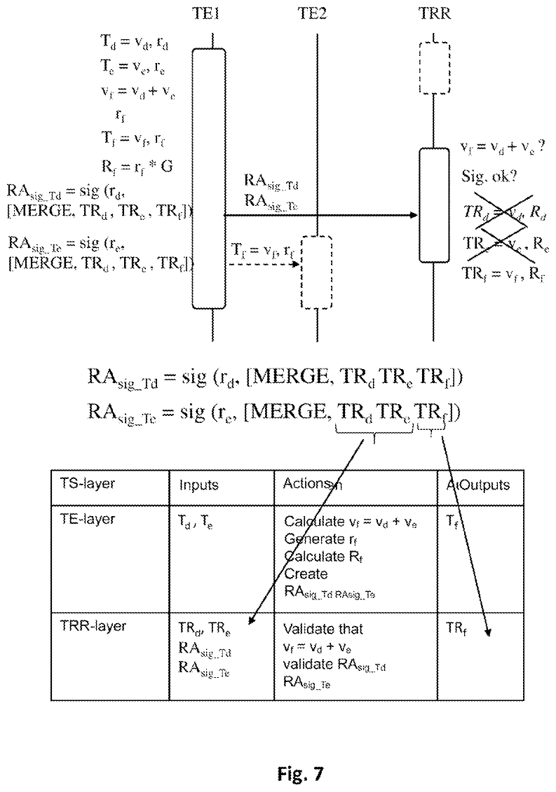

FIG. 7 shows an exemplary embodiment of a flowchart of a method according to the invention for connecting a token T_{d} to a token Tₑ and registering the connected token T_{f} in the TRR. In addition, the signed registration requests RA_{sig_Td} and RA_{sig_Te} required for this as well as the command structure are shown in tabular form both from the point of view of the TE layer and the TR layer.

A random number r_{f} is generated here in a TE1 of the TE layer. Based thereon, a public part R_{f} is then generated. In addition, a sum is formed from the token values v_{d} and vₑ to give the token value v_{f} based on the input tokens T_{d} and Tₑ.

The output token reference TR_{f} is then generated. A registration request RA then contains the command “MERGE” or the command code listed in FIG. 3a, which comprises two input token references TR_{d} and TRₑ as well as the output token reference TR_{f}. This registration request RA is signed once with the random number r_{d} of the token T_{d} in order to obtain a first signed registration request RA_{sig_Td}. This registration request is also signed with the random number rₑ of the token Tₑ in order to obtain a second signed registration request RA_{sig_Te}. Both signed registration requests RA_{sig_Td} and RA_{sig_Te} are sent by the subscriber unit TE1 to the token reference register TRR. The signatures of the registration requests RA_{sig_Td} and RA_{sig_Te} are each checked there. In addition, the sum of the token values v_{d} and vₑ is formed and compared with the token value v_{f}. If v_{f}=v_{d}+vₑ and both signature checks are successful, then TR_{d} and TRₑ will be deleted in the token reference register TRR or marked as deleted, and the token reference TR_{f} will be entered in the token reference register TRR. The connected token T_{b} (which was temporarily transmitted from TE1 to TE2) can now be checked for validity by the subscriber unit TE2 in the TRR.

FIG. 8 shows an exemplary embodiment of a flowchart of a method according to the invention for switching a token T_{g} to a token Tₕ and registering the switched token Tₕ in the shown token reference register TRR. In addition, the signed registration requests RA_{sig_Tg} required for this and the command structure is shown in tabular form both from the point of view of the TE layer and the TR layer.

A random number rₕ is generated here in a TE1. Based thereon, a public part Rₕ is then generated. In addition, the token value vₕ identical to the token value v_{g} of the input token T_{g} is formed.

The token reference TRₕ is then generated. A registration request RA then contains the command “SWITCH” or a corresponding command code according to FIG. 3a, the input token reference TR_{g} and the formed public part Rₕ (or the output token reference TRₕ). This registration request RA is signed with the random number r_{g} of the token T_{g}. The signed registration request RA_{sig_Tg} is sent by the subscriber unit TE1 to the token reference register TRR. The signature is checked there. In addition, the token value v_{g} is compared with the token value vₕ. If v_{g}=vₕ and the signature check is successful, then the token reference TR_{g} in the token reference register TRR will be deleted or marked as deleted, and the token reference TRₕ entered in the token reference register TRR.

FIG. 9 is a further embodiment of a token reference register TRR of a transaction system TS. FIG. 9 indicates that a plurality of memory units 1 can be kept ready in the token reference register TRR in order to accelerate storage of a plurality of token references TR. In addition, it is indicated here that a plurality of verification units 2 and/or check units 3 can be held ready in the token reference register TRR in order to accelerate a verification of registration requests RA.

Registration requests of secure elements or of other subscriber units are processed in one of the verification units 2 and optionally before this in one (of the) optional check unit(s) 3. Registration requests of the token issuer (TH) are optionally processed before the verification (and/or checking) by the new registration unit 4.

The optional total token value check unit 5 checks—for example in a predefined or randomly varying time interval (x, y), such as every x hours or y days, or on request of the check unit 3 ( )—whether the total sum of the token values of valid tokens in the token reference register TRR corresponds to the total token value.

In addition, a subscriber unit TE_{B} is shown which functions as an interface between the transaction system TS and a book money system (credit assignment, account management) and, for example, allows subscriber units TE to transfer tokens T of the transaction system TS into another transaction system. This transfer is bidirectional and can take place using the token issuer TH, which is solely responsible for the new generation of tokens T and also the deletion of tokens T.

1.-18. (canceled)

19. A method for registering tokens of an electronic transaction system, wherein each token of the transaction system comprises at least a token value and a private part of a token-individual key pair as token elements, the method comprising the method steps of:
receiving, in a token reference register of the transaction system, a registration request comprising at least one token reference uniquely assigned to a token of the transaction system,
wherein the token reference comprises at least the token value of the token and a public part of the token-individual key pair as token reference elements,
wherein the public part of the token-individual key pair was obtained by applying a cryptographic one-way function to the private part of the token-individual key pair of the token,
verifying, using a verification unit of the token reference register, whether the at least one token reference of the received registration request is stored in the token reference register, and
storing the at least one token reference in a memory unit of the token reference register in order to register the token uniquely assigned to this token reference in the transaction system if it is established in the verification step that the at least one token reference of the received registration request is not stored in the token reference register.

20. The method according to claim 19, wherein in the verification step by the verification unit of the token reference register, the following is also established:
whether the token reference can be assigned to a token in the received registration request; and/or
whether the received registration request is syntactically correct; and/or
whether a sum of token values of all token references within the registration request is zero.

21. The method according to claim 19, wherein the public key part of the token-individual key pair of the token reference simultaneously is a database index in the token reference register.

22. The method according to claim 19, wherein the received registration request is signed with the private part of the token-individual key pair in order to be able to verify an assignment of the token reference to the token.

23. The method according to claim 19, wherein the registration request is received by a subscriber unit, in particular a secure element; and/or the registration request relates to a modification of at least one previously registered token, and at least the token reference of the at least one previously registered token and the at least one token reference of the token to be registered, which is the modification of the previously registered token.

24. The method according to claim 19, wherein the token reference register also comprises:
the one or more memory units for storing token references for registering the token in the transaction system; and/or
the one or more verification units for verifying received registration requests; and/or
one or more check units for checking the received registration request, in particular for syntactic correctness and/or sum of the token values in the registration request, before the verification; and/or
a check unit for checking a total token value of all token values of registered tokens of the transaction system; and/or
a new registration unit for registering new tokens or deleted tokens as implemented by a token issuer.

25. The method according to claim 19, wherein the token reference comprises at least one of the further token reference elements:
a count value,
an identity of a subscriber unit or of an owner of the subscriber unit, and/or
a pseudonym of a subscriber entity or of an owner of the subscriber unit.

26. The method according to claim 23, wherein the registration request is a splitting of a token, and the registration request comprises a token reference of the token to be split and a token reference of the split token to be registered.

27. The method according to claim 26, wherein for splitting the token the following method steps are carried out in a subscriber unit:
creating a new private part of a token-individual key pair for a first split token,
applying a cryptographic function to the new private part in order to obtain a corresponding public part of the token-individual key pair for the first split token;
creating a new private part of a token-individual key pair for a second split token;
applying a cryptographic function to the new private part to obtain a corresponding public part of the token-individual key pair for the second split token;
splitting the token value into a first token part value and into a second token part value,
wherein the sum of the first token part value and the second token part value corresponds to the token value of the token to be split;
creating a token reference for the first split token comprising the first token part value and the public part of the token-individual key pair of the first split token;
creating a token reference for the second split token comprising the second token part value and the public part of the token-individual key pair of the second split token; and
creating the registration request using the token reference of the token to be split, the token reference for the first split token and the token reference for the second split token.

28. The method according to claim 23, wherein the registration request relates to a switching of a token to be switched to a switched token, and the registration request comprises a token reference of the token to be switched and the token reference of the switched token.

29. The method according to claim 28, wherein for switching the token the following method steps are carried out in a subscriber unit:
creating a new private part of a token-individual key pair,
applying a cryptographic function to the new private part in order to obtain a public part of the token-individual key pair for the switched token;
creating the registration request using the token reference for the token to be switched and the public part of the token-individual key pair for the switched token.

30. The method according to claim 23, wherein the registration request is a connection of at least two tokens and comprises a token reference of the connected token and a token reference of each of the tokens to be connected.

31. The method according to claim 30, wherein for connecting the token the following method steps are carried out in a subscriber unit:
creating a new private part of a token-individual key pair,
applying a cryptographic function to the new private part to obtain a corresponding public part of the token-individual key pair for the connected token;
calculating the token value for the connected token by forming the sum of the respective token values of the tokens to be connected;
creating a token reference for the connected token comprising the calculated token value and the public part of the token-individual key pair for the connected token; and
creating the registration request using each token reference of the tokens to be connected and the token reference for the connected token.

32. The method according to claim 19, wherein the registration request has been sent by a token issuer, and
wherein the registration request relates to a creation of a token or a deletion of a token.

33. A token reference register for a transaction system, configured to perform the method steps according to claim 19.

34. The token reference register according to claim 33, comprising:
at least one memory unit for storing token references for registering tokens in the transaction system;
at least one verification unit for verifying whether a token reference of a received registration request is stored in the token reference register,
a new registration unit for registering a token newly generated by a token issuer or a token deleted by a token issuer,
optionally a check unit for checking the received registration request before the verification by the verification unit, and
optionally a check unit for checking a total sum of the token values of registered token of the transaction system stored in the memory unit.

35. A secure element which is configured as a subscriber unit of a transaction system,
for the direct exchange of tokens with a further subscriber unit, wherein each token of the transaction system comprises at least one token value and a private part of a token-individual key pair as token elements,
for creating a modified token from an existing token to be modified,
wherein a token reference uniquely assigned to the modified token of the transaction system comprises at least the token value of the token and a public part of the token-individual key pair as token reference elements,
wherein the public part of the token-individual key pair is obtained by applying a cryptographic one-way function to the private part of the token-individual key pair of the token, and
for providing a registration request to a token reference register of the transaction system,
wherein the registration request has at least the token reference uniquely assigned to the token of the transaction system.

36. A transaction system comprising:
a register layer with a token reference register according to claim 33 for registering token references; and
a direct transaction layer with a plurality of subscriber units which are designed at least partially as a secure element which is configured as a subscriber unit of a transaction system,
for the direct exchange of tokens with a further subscriber unit, wherein each token of the transaction system comprises at least one token value and a private part of a token-individual key pair as token elements,
for creating a modified token from an existing token to be modified,
wherein a token reference uniquely assigned to the modified token of the transaction system comprises at least the token value of the token and a public part of the token-individual key pair as token reference elements,
wherein the public part of the token-individual key pair is obtained by applying a cryptographic one-way function to the private part of the token-individual key pair of the token, and
for providing a registration request to a token reference register of the transaction system,
wherein the registration request has at least the token reference uniquely assigned to the token of the transaction system.
